(19) United States
(12) Patent Application Publication
(10) Pub. No.: US 2026/0164326 A1
(43) Pub. Date: Jun. 11, 2026

(54) Methods And Apparatus For Radio Access Technology Redirection In Mobile Communications

(71) Applicant: MediaTek Inc., Hsinchu City (TW)

(72) Inventors: Chin-Te Chen, Hsinchu City (TW); Pan-Yen Chiang, Hsinchu City (TW); Yuan-Chieh Lin, Hsinchu City (TW); Ren-Huang Liu, Hsinchu City (TW)

(73) Assignee: MediaTek Inc., Hsinchu City (TW)

(21) Appl. No.: 19/403,800

(22) Filed: Nov. 29, 2025

Related U.S. Application Data
(60) Provisional application No. 63/729,550, filed on Dec. 9, 2024.

(51) Int. Cl. H04W 36/14; H04W 24/10; H04W 68/02; H04W 76/30

(52) U.S. Cl. CPC H04W 36/14; H04W 24/10; H04W 68/02; H04W 76/30

(57) ABSTRACT

Various solutions for radio access technology (RAT) redirection in mobile communications are described. The user equipment (UE) may determine that a requested service is not supported by a current RAT of the UE. Also, the UE may transmit a service request to a network node. Specifically, the service request comprises a service type indicating a service request for other RAT. Further, the UE may receive an accept message from the network node for connection release with redirection to a target RAT. Accordingly, the seamless service continuity across heterogeneous RATs can be ensured.

### CROSS REFERENCE TO RELATED PATENT APPLICATION(S)

The present disclosure is part of a non-provisional application claiming the priority benefit of U.S. Patent Application No. 63/729,550, filed 9 December 2024, the content of which herein being incorporated by reference in its entirety.

### TECHNICAL FIELD

The present disclosure is generally related to mobile communications and, more particularly, to radio access technology (RAT) redirection in mobile communications.

### BACKGROUND

Unless otherwise indicated herein, approaches described in this section are not prior art to the claims listed below and are not admitted as prior art by inclusion in this section.

The transition to sixth generation (6G) brings with it a crucial challenge in managing the coexistence of fifth generation (5G) radio access networks (RAN) and the 6G RAN under a unified core. Specifically, a single core network, whether an evolution of the legacy core network (e5GC) or a revolutionary new core network (6GC), is designed to serve both generations, utilizing common shared network functions. While this architecture provides centralized management, the early phase of deployment presents significant interoperability problems, especially at the RAN level.

A primary concern stems from the potential absence of a direct Xn-like interface between the 5G RAN and 6G RAN. This lack of a standardized inter-RAN interface severely limits the exchange of signaling and radio resource coordination, hindering seamless service delivery. Consequently, a user equipment (UE) camped on a 5G RAN cell connected to the e5GC or the 6GC cannot fully utilize new 6G services such as the integrated communications and computation (ICC), or the service sensing. Conversely, if the UE is attached to a 6G RAN that has not fully integrated legacy 5G functions, it may be unable to access established 5G services (e.g., voice service). This service limitation and priority management become a major user experience concern. Furthermore, without network assistance for coordinated cell selection across different radio access technologies (RATs), the UE's ability to efficiently find a new, suitable cell for service continuity is compromised, potentially leading to a worse service experience during mobility. Accordingly, a more efficient method for RAT redirection is needed.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to radio access technology (RAT) redirection in mobile communications.

In one aspect, a method may involve an apparatus determining that a requested service is not supported by a current RAT of the apparatus. The method may also involve the apparatus transmitting a service request to a network node. Specifically, the service request comprises a service type indicating a service request for other RAT. The method may further involve the apparatus receiving an accept message from the network node for connection release with redirection to a target RAT.

In another aspect, an apparatus may comprise a transceiver which, during operation, wirelessly communicates with a network node of a wireless network. The apparatus may also comprise a processor communicatively coupled to the transceiver. The processor, during operation, may perform operations comprising determining that a requested service is not supported by a current RAT of the apparatus. The processor, during operation, may also perform operations comprising transmitting, via the transceiver, a service request to a network node. Specifically, the service request comprises a service type indicating a service request for other RAT. The processor, during operation, may also perform operations comprising receiving, via the transceiver, an accept message from the network node for connection release with redirection to a target RAT.

In yet another aspect, a method may involve a network node receiving a service request from a user equipment (UE). The service request comprises a service type indicating a service request for other RAT. The method may also involve the network node transmitting an accept message to the UE for releasing a connection with a current RAT of the UE and redirection to a target RAT.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to radio access technology (RAT) redirection in mobile communications. According to the present disclosure, a number of possible solutions may be implemented separately or jointly. That is, although these possible solutions may be described below separately, two or more of these possible solutions may be implemented in one combination or another.

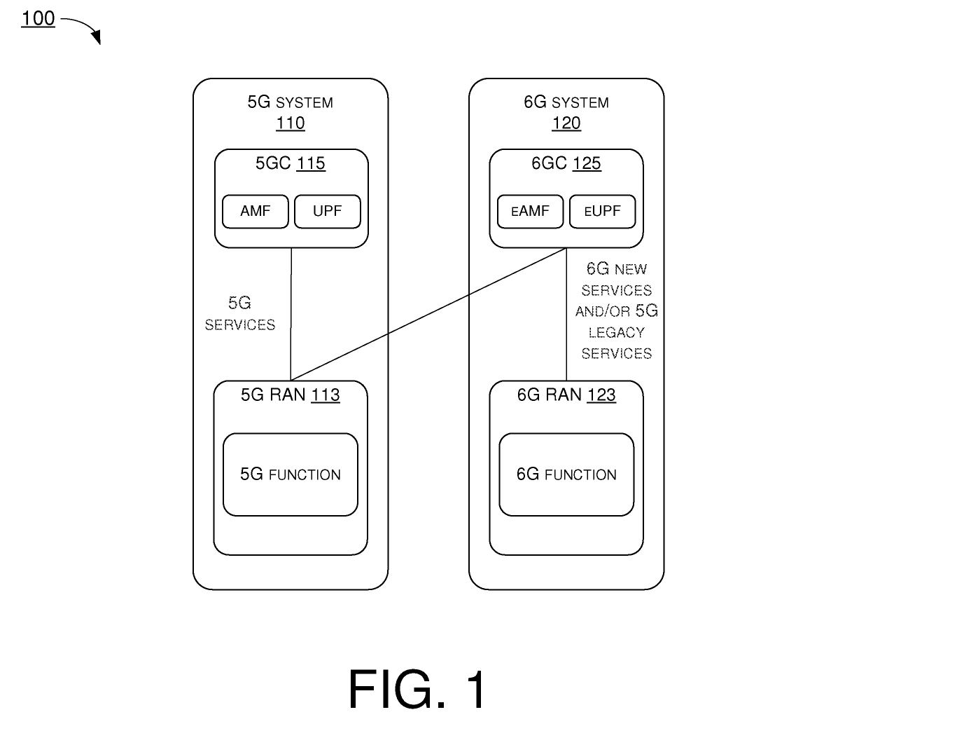

FIG. 1 illustrates an example scenario 100 of a communication environment in which various solutions and schemes in accordance with the present disclosure may be implemented. Scenario 100 involves a fifth generation (5G) system 110 and a sixth generation (6G) system 120. The 5G system 110 comprises a 5G radio access network (5G RAN) 113 and a 5G core network (5GC) 115, while the 6G system 120 comprises a 6G radio access network (6G RAN) 123 and a 6G core network (6GC) 125. It should be noted that the 6G core network may also be referred to as an evolution or enhanced of the legacy core network, such as an evolution or enhanced of the 5GC (may be referred to as e5GC). In one embodiment, the 5G RAN 113 is connected to the 5GC 115 by means of the NG interface, more specifically to a user plane function (UPF) by means of the NG user-plane part (NG-u), and to an access and mobility management function (AMF) by means of the NG control-plane part (NG-c). Similarly, the 6G RAN 123 is connected to a user plane function (eUPF) and an access and mobility management function (eAMF) in the 6GC 125 through specific interface(s).

In scenario 100, due to the close architectural affinity between the 5GC 115 and the 6GC 125, interworking and resource sharing are feasible, enabling the 6GC 125 to manage both the 5G RAN 113 and the 6G RAN 123. Given the asymmetry of services provided by the 5G system 110 and the 6G system 120, a user equipment (UE) camped on a cell of one RAN may determine that the current RAT cannot support the required service. For example, the UE is camped on a 5G cell and knows that 5G RAT lacks support for new services such as, for example and without limitation, service sensing or integrated communications and computation (ICC), or the UE is camped on a 6G cell and knows that 6G RAT does not support mobile-originated (MO) or mobile-terminated (MT) voice calls. In such cases, a UE-initiated mobility may be triggered by public land mobile network (PLMN) search or cell selection. Alternatively, a network-initiated mobility may be triggered by a service request sent by the UE. This request is differentiated by including a service type information element (IE) whose value explicitly specifies a service request for the other RAT. In one embodiment, the service type is encoded using 4 bits. For instance, the value "0010" is assigned to mobile terminated services, whereas the value "1100" is assigned to service request for other RAT. However, the value and format of the service type are not restricted to this example.

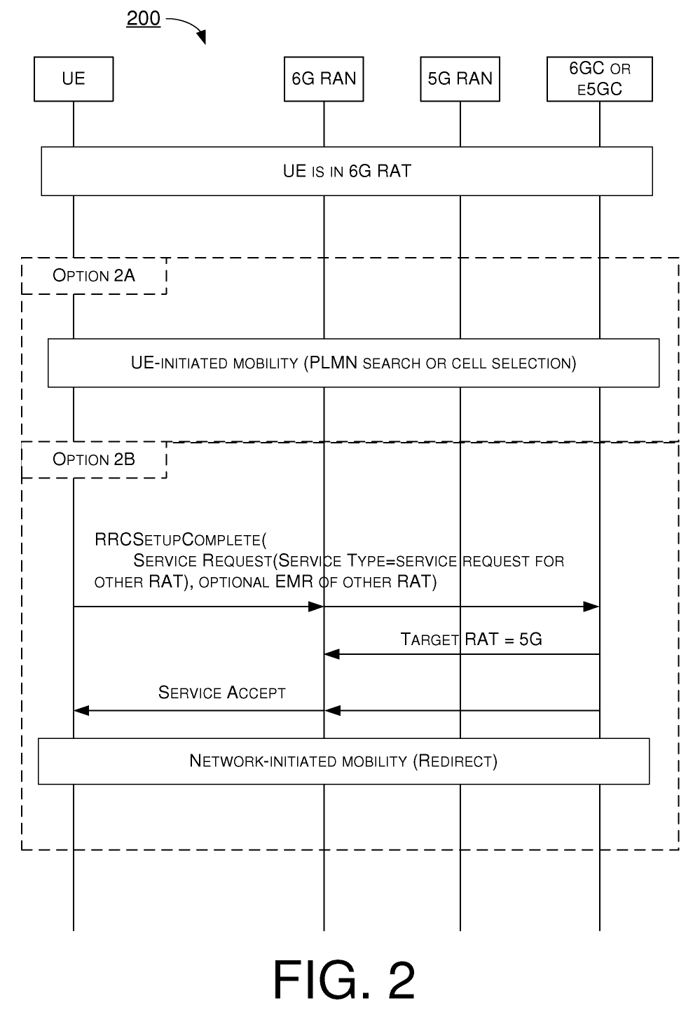

FIG. 2 illustrates an example scenario 200, in which the 5G RAN and the 6G RAN are managed by a single core network (6GC or e5GC), and a UE is camped on the 6G RAT but needs to switch to the 5G RAT for an MO voice call. Following MO service initiation, the UE may perform a RAT selection to determine a service RAT candidate (e.g., 5G RAT). If the service RAT candidate differs from the current RAT of the UE (i.e., 6G RAT), the UE has two methods for triggering inter-RAT mobility. In option 2A, a UE-initiated mobility may involve the UE autonomously executing procedures such as PLMN search or cell selection to transition to the 5G RAT. Specifically, the UE may camp on a new cell in the 5G RAT, followed by initiating a radio resource control (RRC) connection setup procedure. Once the connection is established, the UE sends a non-access stratum (NAS) service request message to the 6GC or e5GC, which ultimately leads to the triggering of user-plane resource activation. On the other hand, option 2B allows the UE to prompt the network to initiate the mobility procedure. To be specific, the UE may initiate an RRC connection setup procedure, and upon receiving an RRC setup (RRCSetup) message, the UE sends an RRC setup complete (RRCSetupComplete) message to the 6G RAN. This RRC setup complete message is critical as it embeds a service request (e.g., a NAS service request) that contains a specific service type indicating a request for service from the other RAT (in this case, 5G). Optionally, to aid the network in making efficient mobility decisions, the UE may also include an early measurement report (EMR) of the 5G cell(s) within the RRC setup complete message, providing vital radio condition information. The 6G RAN forwards this request to the 6GC or e5GC, which then determines the target RAT as 5G. The 6GC or e5GC subsequently confirms this decision by sending a service accept message back to the UE. In one example, the service accept message may include a target frequency of the 5G RAT determined based on the EMR. This successful negotiation then triggers the final phase, which is a network-initiated mobility (redirect) procedure that ensures a coordinated handover to the 5G RAN.

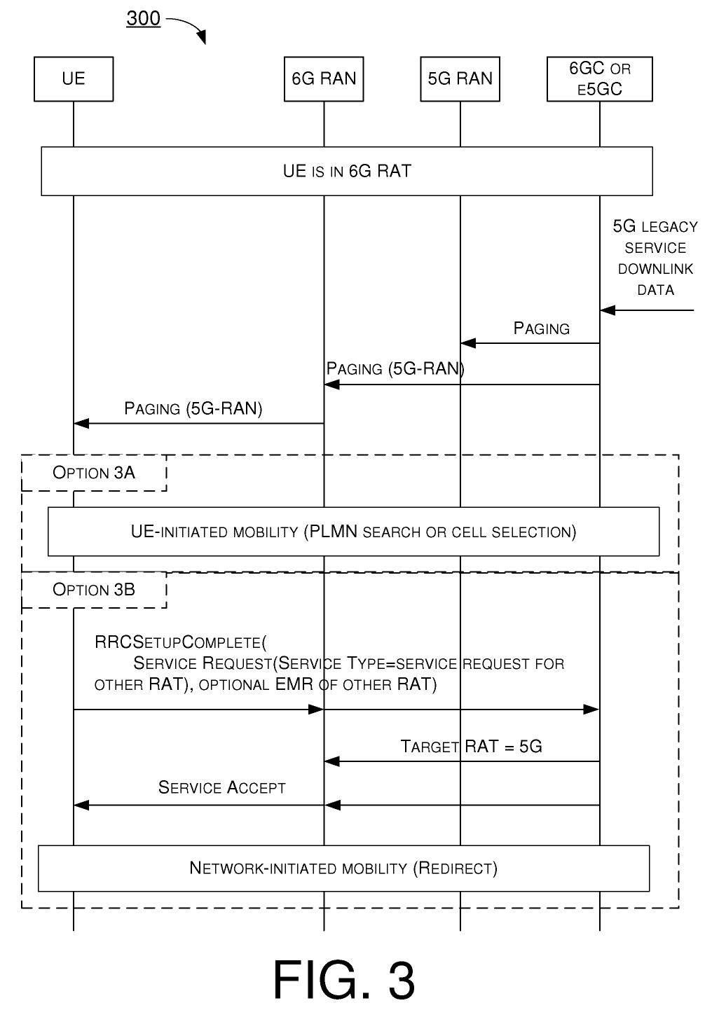

FIG. 3 illustrates an example scenario 300, in which the 5G RAN and the 6G RAN are managed by a single core network (6GC or e5GC), and a UE camps on the 6G RAT but needs to switch to the 5G RAT for an MT voice call. S cenario 300 involves a new paging field called paging response RAT, which is included within the paging record (e.g., PagingRecord-XY) to facilitate the UE's response to the MT service request on the other RAT. When 5G legacy service downlink data arrives, the 6GC or e5GC triggers paging to both the 5G RAN and 6G RAN. The UE, currently in the 6G RAT, receives the paging message. The UE determines that the MT call is not supported by the current RAT because the current RAT is different from the paging response RAT. At this point, the UE has two mobility options. Option 3A describes the UE autonomously switching to the target RAT (e.g., 5G) based on the paging response RAT information, utilizing procedures such as PLMN search or cell selection. This process involves the UE first camping on a new cell in the 5G RAT, then initiating the RRC connection setup procedure, sending a NAS service request message, and finally triggering a user-plane resource activation. On the other hand, in option 3B, the UE sends an RRC setup complete (RRCSetupComplete) message containing a service request with a service type value indicating a service request for other RAT. In one example, the UE may also provide the EMR of the neighboring cell(s) in 5G RAT. The 6GC or e5GC designates the target RAT as 5G, sends a service accept message indicating a target frequency of the 5G RAT, and then triggers a network-initiated mobility (redirect) to complete the transition.

The present disclosure enables seamless service continuity across heterogeneous RATs such as the 6G and 5G domains by offering the UE two flexible mobility options. The UE may either immediately switch to the target RAT or send a service request indicating a service request for the other RAT to the network node along with an optional measurement report, thereby ensuring robust service continuity across different RATs.

### Illustrative Implementations

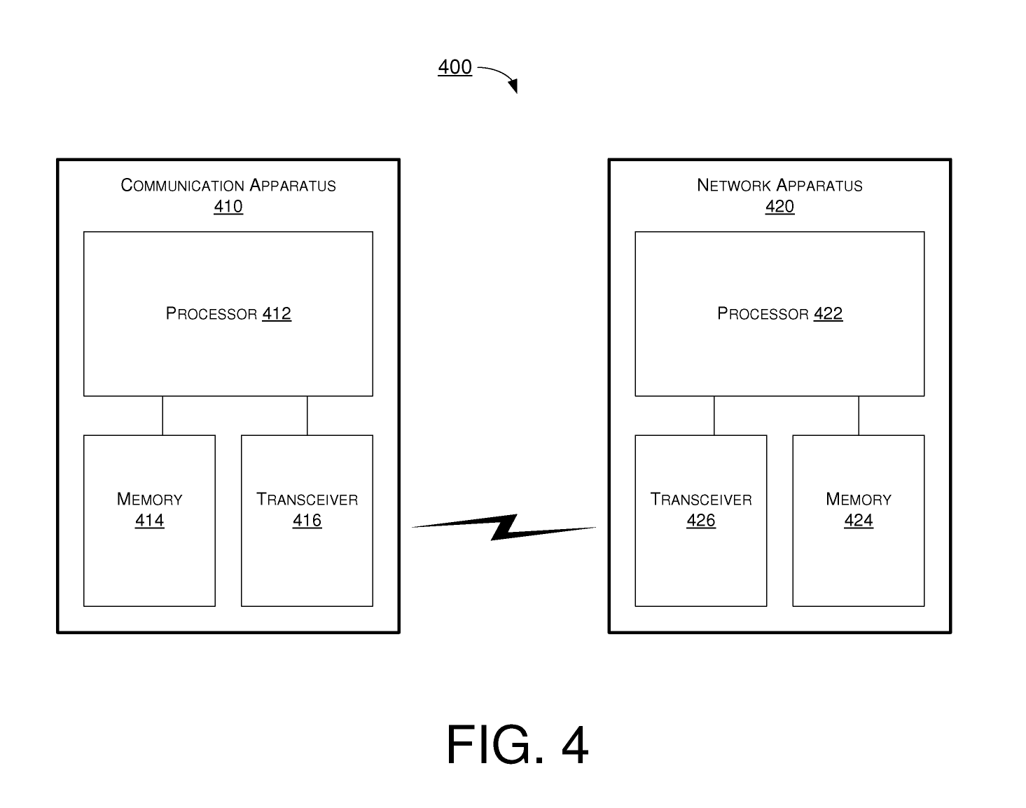

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to RAT redirection in mobile communications, including scenarios/schemes described above as well as process 500 and process 600 described below.

Communication apparatus 410 may be a part of an electronic apparatus, which may be a UE such as a portable or mobile apparatus, a wearable apparatus, a wireless communication apparatus, or a computing apparatus. For instance, communication apparatus 410 may be implemented in a smartphone, a smartwatch, a personal digital assistant, a digital camera, or a computing equipment such as a tablet computer, a laptop computer, or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router, a gateway, or other network element. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including RAT redirection in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively.

To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

### Illustrative Processes

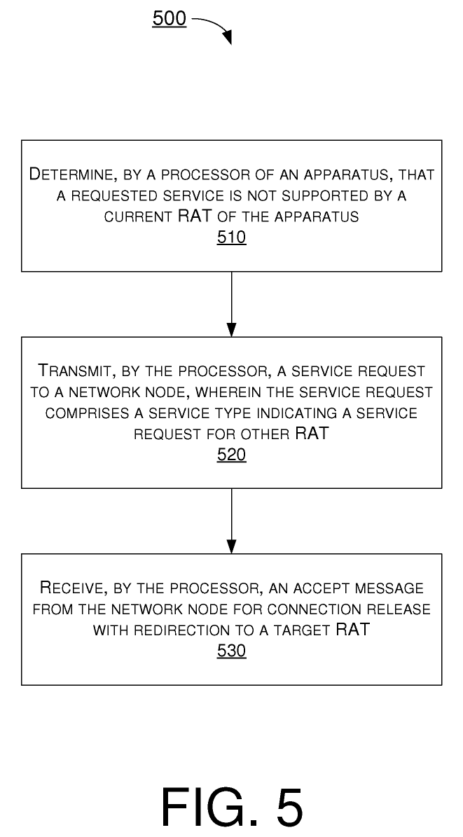

FIG. 5 illustrates an example process 500 in accordance with an implementation of the present disclosure. Process 500 may be an example implementation of above scenarios/schemes, whether partially or completely, with respect to RAT redirection of the present disclosure. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At block 510, process 500 may involve processor 412 of communication apparatus 410 determining that a requested service is not supported by a current RAT of communication apparatus 410. Process 500 may proceed from block 510 to block 520.

At block 520, process 500 may involve processor 412 of communication apparatus 410 transmitting, via transceiver 416, a service request to a network node (e.g., network apparatus 420). The service request comprises a service type indicating a service request for other RAT. Process 500 may proceed from block 520 to block 530.

At block 530, process 500 may involve processor 412 of communication apparatus 410 receiving, via transceiver 416, an accept message from the network node for connection release with redirection to a target RAT.

In some implementations, process 500 may further involve processor 412 of communication apparatus 410 transmitting, via transceiver 416, an EMR of at least one neighboring cell in the target RAT.

In some implementations, the accept message may include a target frequency of the target RAT determined based on the EMR of the at least one neighboring cell.

In some implementations, the requested service comprises an MO call, an ICC, or a service sensing. However, the present disclosure is not limited thereto.

In some implementations, process 500 may further involve processor 412 of communication apparatus 410 selecting a candidate RAT as the target RAT. Furthermore, process 500 may involve processor 412 of communication apparatus 410 switching to the target RAT.

In some implementations, the requested service may include an MT call. Process 500 may involve processor 412 of communication apparatus 410 receiving, via transceiver 416, a paging message indicating a paging response RAT.

In some implementations, process 500 may involve processor 412 of communication apparatus 410 determining that the MT call is not supported by the current RAT in an event that the current RAT is different from the paging response RAT.

In some implementations, process 500 may involve processor 412 of communication apparatus 410 switching to the target RAT based on the paging response RAT.

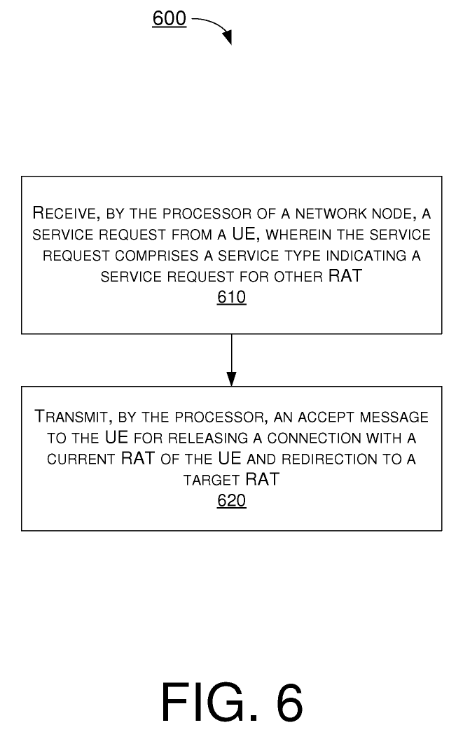

FIG. 6 illustrates an example process 600 in accordance with an implementation of the present disclosure. Process 600 may be an example implementation of above scenarios/schemes, whether partially or completely, with respect to RAT redirection in mobile communications. Process 600 may represent an aspect of implementation of features of network apparatus 420. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any base stations or network nodes. Solely for illustrative purposes and without limitation, process 600 is described below in the context of network apparatus 420. Process 600 may begin at block 610.

At block 610, process 600 may involve processor 422 of network apparatus 420 receiving, Via Transceiver 426, a service request from a UE (e.g., communication apparatus 410) to be specific, the service request may include a service type indicating a service request for other RAT. Process 600, may proceed from block 610 to block 620.

At block 620, process 600 may involve processor 422 of network apparatus 420 transmitting, via transceiver 426, an accept message to the UE for releasing a connection with a current RAT of the UE and redirection to a target RAT.

In some implementations, process 600 may also involve processor 422 of network apparatus 420 receiving, via transceiver 426, an EMR of at least one neighboring cell in the target RAT from the UE.

In some implementations, process 600 may also involve processor 422 of network apparatus 420 including a target frequency of the target RAT in the accept message. The target frequency is determined based on the EMR of the at least one neighboring cell.

In some implementations, process 600 may also involve processor 422 of network apparatus 420 transmitting, via transceiver 426, a paging message indicating a paging response RAT to the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, that a requested service is not supported by a current radio access technology (RAT) of the apparatus;
transmitting, by the processor, a service request to a network node, wherein the service request comprises a service type indicating a service request for other RAT; and
receiving, by the processor, an accept message from the network node for connection release with redirection to a target RAT.

2. The method of claim 1, further comprising:
transmitting, by the processor, an early measurement report (EMR) of at least one neighboring cell in the target RAT.

3. The method of claim 2, wherein the accept message comprises a target frequency of the target RAT determined based on the EMR of the at least one neighboring cell.

4. The method of claim 1, wherein the requested service comprises a mobile-originated (MO) call, an integrated communications and computation (ICC), or a service sensing.

5. The method of claim 1, further comprising:
selecting, by the processor, a candidate RAT as the target RAT; and
switching, by the processor, to the target RAT.

6. The method of claim 1, wherein the requested service comprises a mobile-terminated (MT) call, and the method further comprises:
receiving, by the processor, a paging message indicating a paging response RAT.

7. The method of claim 6, wherein the determining of the requested service is not supported by the current RAT further comprises:
determining that the MT call is not supported by the current RAT in an event that the current RAT is different from the paging response RAT.

8. The method of claim 6, further comprising:
switching, by the processor, to the target RAT based on the paging response RAT.

9. An apparatus, comprising:
a transceiver which, during operation, communicates wirelessly; and
a processor communicatively coupled to the transceiver such that, during operation, the processor performs operations comprising:
determining that a requested service is not supported by a current radio access technology (RAT) of the apparatus;
transmitting, via the transceiver, a service request to a network node, wherein the service request comprises a service type indicating a service request for other RAT; and
receiving, via the transceiver, an accept message from the network node for connection release with redirection to a target RAT.

10. The apparatus of claim 9, wherein during operation, the processor further performs operations comprising:
transmitting, via the transceiver, an early measurement report (EMR) of at least one neighboring cell in the target RAT.

11. The apparatus of claim 10, wherein the accept message comprises a target frequency of the target RAT determined based on the EMR of the at least one neighboring cell.

12. The apparatus of claim 9, wherein the requested service comprises a mobile-originated (MO) call, an integrated communications and computation (ICC), or a service sensing.

13. The apparatus of claim 9, wherein during operation, the processor further performs operations comprising:
selecting a candidate RAT as the target RAT; and
switching to the target RAT.

14. The apparatus of claim 9, wherein the requested service comprises a mobile-terminated (MT) call, and during operation, the processor further performs operations comprising:
receiving, via the transceiver, a paging message indicating a paging response RAT.

15. The apparatus of claim 14, wherein during operation, the processor further performs operations comprising:
determining that the MT call is not supported by the current RAT in an event that the current RAT is different from the paging response RAT.

16. The apparatus of claim 14, wherein during operation, the processor further performs operations comprising:
switching to the target RAT based on the paging response RAT.

17. A method, comprising:
receiving, by the processor of a network node, a service request from a user equipment (UE), wherein the service request comprises a service type indicating a service request for other radio access technology (RAT); and
transmitting, by the processor, an accept message to the UE for releasing a connection with a current RAT of the UE and redirection to a target RAT.

18. The method of claim 17, further comprising.
receiving, by the processor, an early measurement report (EMR) of at least one neighboring cell in the target RAT from the UE.

19. The method of claim 18, further comprising:
including, by the processor, a target frequency of the target RAT in the accept message, wherein the target frequency is determined based on the EMR of the at least one neighboring cell.

20. The method of claim 17, further comprising:
transmitting, by the processor, a paging message indicating a paging response RAT to the UE.
